(19) United States
(12) Patent Application Publication
(10) Pub. No.: US 2026/0274465 A1
(43) Pub. Date: Sep. 17, 2026

(54) ELECTRIC FLYING OBJECT

(71) Applicant: MITSUBISHI HEAVY INDUSTRIES, LTD., Tokyo (JP)

(72) Inventors: Satoshi YAMASHITA, Tokyo (JP); Yoshihiro KUWAMURA, Tokyo (JP); Yuki MORISAKI, Tokyo (JP); Suguru HASE, Tokyo (JP); Yuichi NAKATANI, Tokyo (JP); Yuki ODA, Tokyo (JP); Junji IWATANI, Tokyo (JP)

(73) Assignee: MITSUBISHI HEAVY INDUSTRIES, LTD., Tokyo (JP)

(21) Appl. No.: 19/168,663

(22) PCT Filed: Oct. 16, 2023
(86) PCT No.: PCT/JP2023/037383

§ 371 Date: Sep. 24, 2025

(30) Foreign Application Priority Data
Mar. 30, 2023 (JP) 2023-054541

(51) Int. Cl. B64U 50/18; B64U 10/13; B64U 30/26; B64U 50/19; B64U 50/23

(52) U.S. Cl. CPC B64U 50/18; B64D 31/09; B64U 10/13; B64U 30/26; B64U 50/19

(57) ABSTRACT

This electric flying object includes an airframe, a plurality of pairs of propulsors provided around the center of gravity of the airframe when viewed in a plan view, each pair being across the center of gravity, and a control unit that controls operation of the propulsors, wherein: each propulsor includes a fan rotatable around its axis line, an electric motor that drives rotation of the fan, a duct that covers the fan from the outer circumferential side, a thrust vectoring unit that thrust-vectors an airflow generated by the duct on the inner circumferential side of the duct, and a thrust vectoring actuator unit that controls the angle of the thrust vectoring unit; and when any one of the plurality of propulsors is abnormally stopped, the control unit switches the propulsor located on the opposite side of the stopped propulsor across the center of gravity to an abnormality correspondence mode.

### TECHNICAL FIELD

The present disclosure relates to an electric flying object.

This application claims the right of priority based on Japanese Patent Application No. 2023-054541 filed with the Japan Patent Office on Mar. 30, 2023, the content of which is incorporated herein by reference.

### BACKGROUND ART

In recent years, the use of electric flying objects typified by drones and multicopters has been expanding (for example, PTL 1 below). An electric flying object mainly includes an airframe and a plurality of propulsors provided in the airframe. The rotation speed of the propulsor can be controlled. When one of the plurality of propulsors is stopped due to abnormality, it is common to control the rotation speeds of the remaining propulsors to control the posture of the airframe.

### CITATION LIST

### Patent Literature

[PTL 1] PCT Japanese Translation Patent Publication No. 2018-529571

### SUMMARY OF INVENTION

### Technical Problem

However, in a case where the posture of the airframe is controlled only by controlling the rotation speed as described above, there is a problem in that although it is possible to adjust a pitching angle, it is difficult to precisely adjust a rolling angle or a yawing angle.

The present disclosure has been made to solve the above-described problems, and an object of the present disclosure is to provide an electric flying object in which it is possible to more precisely control a posture of an airframe at the time of abnormality occurrence.

### Solution to Problem

In order to solve the above problems, an electric flying object according to the present disclosure includes: an airframe; a plurality of propulsors provided in pairs to sandwich a center of gravity of the airframe when viewed in a plan view; and a control unit that controls an operation of the propulsor, in which the propulsor includes a fan rotatable around an axis, an electric motor that rotationally drives the fan, a duct that covers the fan from an outer periphery side, a thrust vectoring unit that thrust-vectors an airflow direction generated by the duct on an inner periphery side of the duct, and a thrust vectoring actuator unit that controls an angle of the thrust vectoring unit, and the control unit switches, in a case where any one of the plurality of propulsors is stopped due to abnormality, the propulsor located on an opposite side to the stopped propulsor with the center of gravity interposed therebetween to an abnormality response mode.

### Advantageous Effects of Invention

According to the present disclosure, it is possible to provide an electric flying object in which it is possible to more precisely control a posture of an airframe at the time of abnormality occurrence. dr

### BRIEF DESCRIPTION OF DRAWINGS

FIG. 1 is a plan view showing a configuration of an electric flying object according to an embodiment of the present disclosure.

FIG. 2 is a schematic sectional view showing a configuration of a propulsor according to the embodiment of the present disclosure.

FIG. 3 is a functional block diagram showing a configuration of a control unit according to the embodiment of the present disclosure.

FIG. 4 is a flowchart showing a control flow when the control unit according to the embodiment of the present disclosure causes an airframe to move horizontally.

FIG. 5 is an explanatory diagram showing an operation of a thrust vectoring unit and a thrust direction when the airframe moves horizontally, and is a view when the airframe is viewed from above.

FIG. 6 is an explanatory diagram showing the relationship between the operation of the thrust vectoring unit, the thrust direction, and the magnitude of the thrust when the airframe moves horizontally, and is a view when the airframe is viewed in a horizontal direction.

FIG. 7 is an explanatory diagram showing the operation of the thrust vectoring unit and the thrust direction when the airframe is rotated around a yaw axis.

FIG. 8 is a flowchart showing a control flow that is executed by the control unit according to the embodiment of the present disclosure when abnormality occurs in a propulsor.

FIG. 9 is an explanatory diagram showing an operating state of the propulsor at the time of abnormality occurrence.

FIG. 10 is a plan view showing a first modification example of the electric flying object according to the embodiment of the present disclosure.

FIG. 11 is a plan view showing a second modification example of the electric flying object according to the embodiment of the present disclosure.

FIG. 12 is a schematic diagram showing a modification example of the thrust vectoring unit according to the embodiment of the present disclosure.

FIG. 13 is a hardware configuration diagram of the control unit according to the embodiment of the present disclosure.

### DESCRIPTION OF EMBODIMENTS

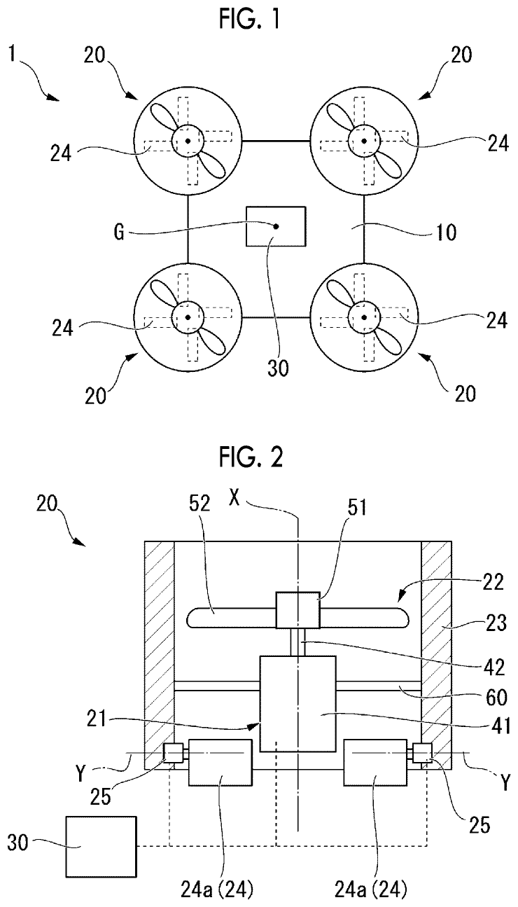

Hereinafter, an electric flying object 1 according to an embodiment of the present disclosure will be described with reference to FIGS. 1 to 7. The electric flying object 1 according to the present embodiment is assumed to be used for ascending or descending of materials between a low place and a high place in addition to the transportation of articles between two points.

### (Configuration of Electric Flying Object 1)

As shown in FIG. 1, the electric flying object 1 includes an airframe 10, a propulsor 20, and a control unit 30. The airframe 10 accommodates various devices such as a battery, a GPS sensor, and a transmission/reception device. Although not shown in detail, the airframe 10 may be formed with a space for loading articles or cargo. In the example of FIG. 1, the airframe 10 has a rectangular shape in a plan view as an example. One propulsor 20 is disposed in each of four corners of the airframe 10. That is, a pair of propulsors 20 is provided on each diagonal line with a geometric gravity center position G of the rectangular airframe 10 interposed therebetween, and a total of four propulsors 20 are provided.

### (Configuration of Propulsor 20)

The propulsor 20 is a device for generating thrust when the airframe 10 ascends or descends, moves horizontally, and yaws. As shown in FIG. 2, the propulsor 20 includes an electric motor 21, a fan 22, a duct 23, a thrust vectoring unit 24, and a thrust vectoring actuator unit 25.

The electric motor 21 includes an electric motor main body 41 and an output shaft 42. The electric motor main body 41 accommodates a stator and a rotor core. The output shaft 42 is integrally connected to the rotor core. The output shaft 42 extends along an axis X and is rotatable around the axis X. The fan 22 is attached to a shaft end of the output shaft 42. The fan 22 includes a spinner 51 and a blade 52. The spinner 51 has a disk shape centered on the axis X. The spinner 51 may have a pointed shape protruding in the direction of the axis X. The spinner 51 rotates around the axis X in an integrated manner with the output shaft 42.

A plurality of blades 52 extending in a radial direction from an outer peripheral surface of the spinner 51 are provided at intervals in a circumferential direction. In the example of FIGS. 1 and 2, two blades 52 are provided. The number of blades 52 is not limited to two, and may be three or more. The blade 52 has an airfoil-shaped cross-sectional shape when viewed in the radial direction. The blades 52 rotate around the axis X together with the spinner 51, so that a flow of air from one side toward the other side in the direction of the axis X is generated. The pressure (dynamic pressure) of the flow of the air serves as thrust for ascending or the like of the airframe 10. In the following description, in a flowing direction of an airflow, a side to which the airflow flows away may be referred to as a “downstream side”, and a side opposite to the downstream side may be referred to as an “upstream side”.

As shown in FIG. 2, the duct 23 has a tubular shape that covers the electric motor 21 and the fan 22 from an outer periphery side. That is, the duct 23 has a tubular shape centered on the axis X. The space inside the duct 23 serves as a flow path through which the airflow generated by the blade 52 passes. The duct 23 is connected to the electric motor main body 41 by a stay 60. A plurality of the stays 60 extend in the radial direction and are provided at intervals in the circumferential direction. In addition, the electric motor main body 41 may be accommodated in an inner cylinder, and the duct 23 may be supported by bridging the stay 60 between the inner cylinder and the duct 23.

The thrust vectoring unit 24 is a device for thrust-vectoring the airflow flowing out from the duct 23 to change a thrust direction. The thrust vectoring unit 24 protrudes from the inner peripheral surface of the duct 23 toward a radial inner side, and is rotatable around a rotation axis Y extending in the radial direction. The thrust vectoring unit 24 is formed of a plate-shaped flap 24a that extends toward the downstream side from the rotation axis Y. As shown in FIG. 1, four thrust vectoring units 24 are provided at intervals of 90°in the circumferential direction. The thrust vectoring actuator unit 25 is connected to each of the thrust vectoring units 24. As shown in FIG. 2, the thrust vectoring actuator unit 25 is an actuator that rotates the thrust vectoringunit 24 around the rotation axis Y. The thrust vectoring actuator unit 25 is electrically connected to a control unit 30 (described later), and a drive state thereof is controlled based on an electric signal sent from the control unit 30. Each of the thrust vectoring units 24 is configured to be controlled independently of each other.

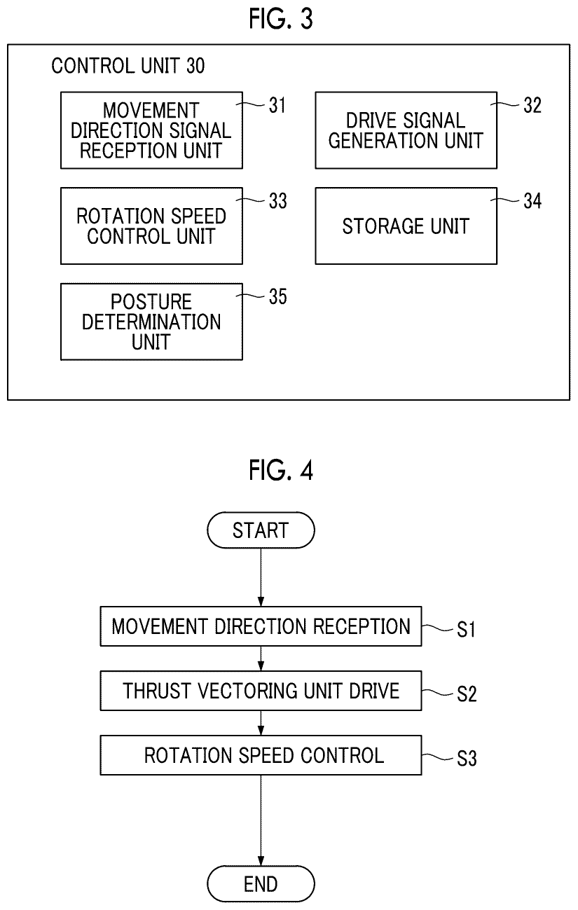

As shown in FIG. 3, the control unit 30 includes a movement direction signal reception unit 31, a drive signal generation unit 32, a rotation speed control unit 33, a storage unit 34, and a posture determination unit 35. The movement direction signal reception unit 31 acquires a direction in which the airframe 10 is to be moved, for example, based on a signal input by an operator via remote control. In the following description, the direction in which the airframe 10 moves is simply referred to as a “movement direction D”. The movement direction D is any direction in the horizontal plane.

The drive signal generation unit 32 transmits a signal for driving the thrust vectoring unit 24 to the thrust vectoring actuator unit 25, based on the movement direction D received by the movement direction signal reception unit 31. That is, which thrust vectoring unit 24 is rotated in which direction and by how much is determined depending on the movement direction D.

The rotation speed control unit 33 controls the rotation speed of each propulsor 20, based on the movement direction D. Details of the operation of the rotation speed control unit 33 will be described later. The storage unit 34 stores various types of information as electric signals. For example, the relationship between the movement direction D, the moving speed, the rotation angle of the thrust vectoring unit 24, and the rotation speed of the propulsor 20, and the like, are stored in the storage unit 34 in advance. The posture determination unit 35 determines whether or not the posture is in a normal state and whether or not the altitude of the airframe 10 maintains a predetermined value, based on information about the posture of the airframe 10 input from a gyro sensor (not shown) or the like.

### (Regarding Operation In Normal State)

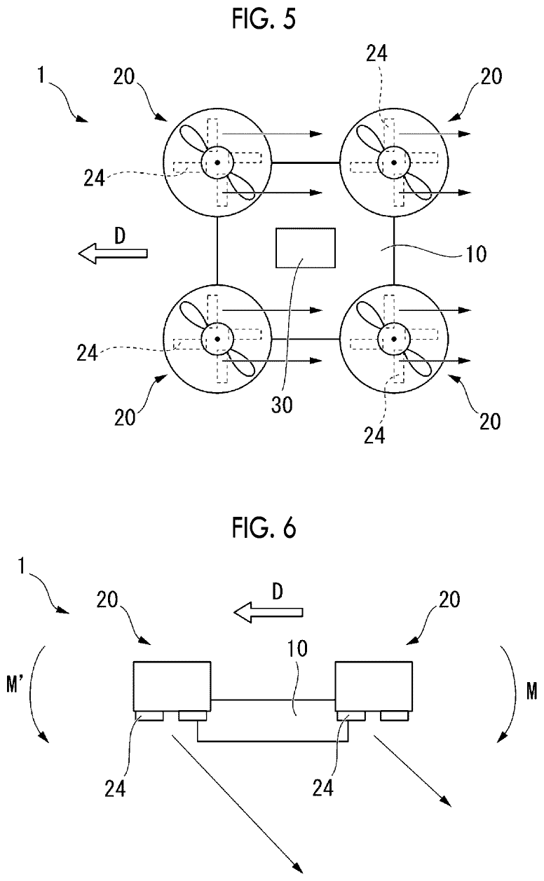

Next, the behavior of each device when the electric flying object 1 moves horizontally in the movement direction D will be described with reference to FIGS. 4 to 6. As shown in FIG. 4, when the movement direction D is input by the operator, in step S1, the movement direction signal reception unit 31 receives information about the movement direction D. Subsequently, in step S2, the thrust vectoring unit 24 is driven in accordance with the movement direction D. Specifically, the drive signal generation unit 32 that receives a signal related to the movement direction D from the movement direction signal reception unit 31 transmits a predetermined electric signal to the thrust vectoring actuator unit 25. In this way, the thrust vectoring unit 24 rotates by a predetermined angle in a predetermined direction. Then, the direction (thrust direction) of the airflow flowing out from the duct 23 is changed. In this way, thrust as a reaction force of the airflow toward a side opposite to the movement direction D is applied to the airframe 10 (refer to FIG. 5).

At this time, as shown in FIG. 6, when viewed from the horizontal direction orthogonal to the movement direction D, a pitching moment M with the direction as an axis is generated in the airframe 10. Specifically, for example, when the airframe 10 is moved to the left side on the paper surface as shown in FIG. 6, the pitching moment M in a clockwise direction is generated in the airframe 10. When the pitching moment M increases, the airframe 10 is inclined in the clockwise direction. Therefore, the rotation speed control unit 33 generates a counter-moment M′ for offsetting the pitching moment M by controlling the rotation speed of the propulsor 20 (step S3). In a case where the plurality of propulsors 20 are considered to be divided into the propulsor 20 that is located on one side (a moving side: a front side) in the movement direction D with the center of gravity of the airframe 10 interposed therebetween, and the propulsor 20 that is located on the other side (a rear side), the rotation speed control unit 33 controls the rotation speed of the propulsor 20 located on the one side in the movement direction D to be higher than the rotation speed of the propulsor 20 on the other side. That is, the thrust by the propulsor 20 on the one side is made larger than the thrust by the propulsor 20 on the other side such that a difference in momentum of the fluid flowing out from the propulsor 20 is indicated by a difference in length of arrows in FIG. 6. Then, the counter-moment M′ in a counterclockwise direction is generated. In this way, the pitching moment M described above is canceled out. Therefore, the airframe 10 moves toward one side in the movement direction D without tilting, that is, without pitching.

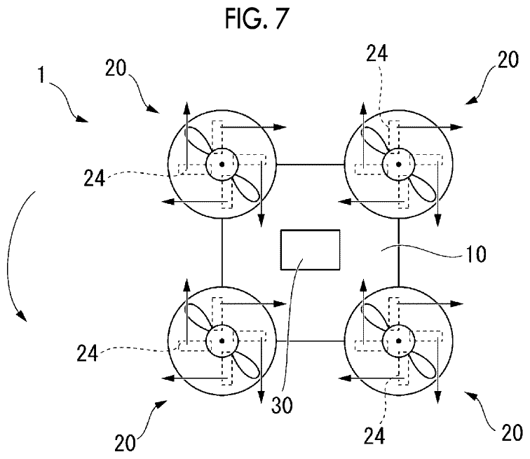

Further, it is also possible to yaw the airframe 10 by operating the thrust vectoring unit 24, in addition to the horizontal movement in the movement direction D. Yawing refers to an operation of rotating the airframe 10 around a yaw axis passing through the center of gravity of the airframe 10. As shown in FIG. 7, when yawing is performed, the thrust vectoring units 24 of the respective propulsors 20 are rotated by the same angle in the same direction, so that thrust is generated in the circumferential direction around the axis X. That is, in each of the propulsors 20, thrust is generated from one side toward the other side in the circumferential direction. In this way, a moment is generated around the yaw axis from one side toward the other side in the circumferential direction in the entire electric flying object 1, and a yawing motion is performed. By appropriately combining the horizontal movement and the yawing motion as described above, the movement and the posture of the electric flying object 1 are controlled.

### (Regarding Operation at Time of Abnormality Occurrence)

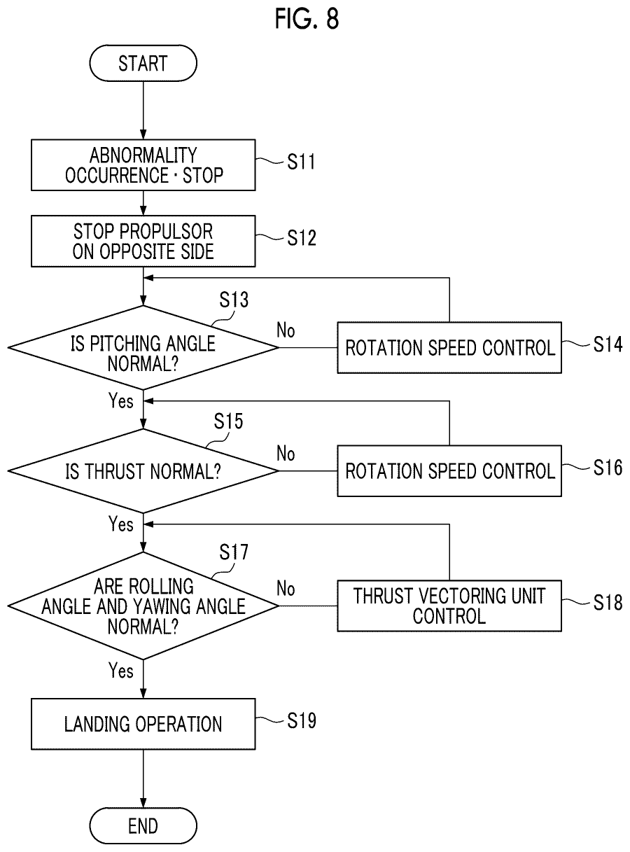

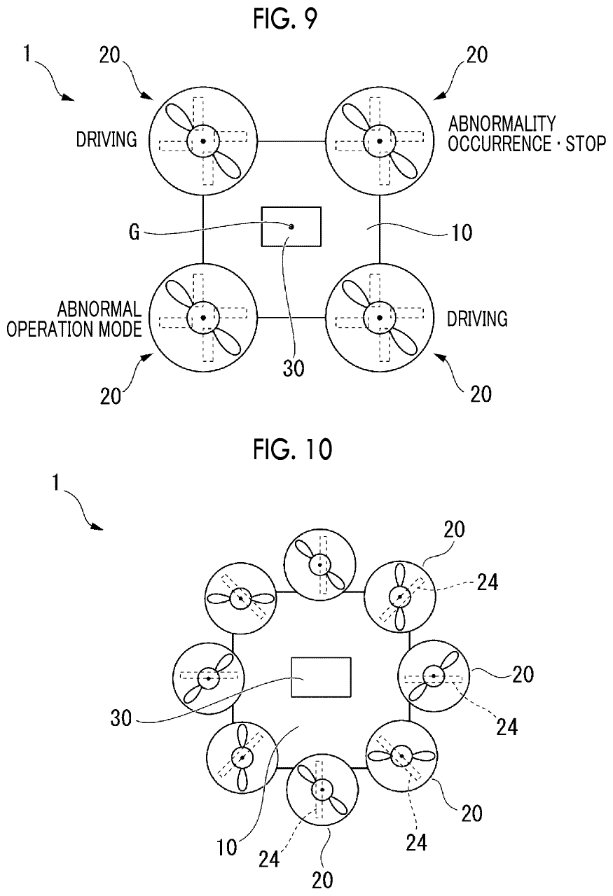

Next, an operation in a case where abnormality occurs in one of the propulsors 20 will be described with reference to FIGS. 8 and 9. The “abnormality” referred to herein refers to a state where the electric motor 21 of the propulsor 20 does not drive, a state where the thrust vectoring unit 24 does not operate, or a state where the fan 22 is damaged and thrust is not generated. In a case where such abnormality occurs in one of the four propulsors 20, the control unit 30 executes a control flow shown in FIG. 8.

First, the propulsor 20 in which abnormality has occurred is stopped (step S11). In this state, flight will continue only by the remaining three propulsors 20. Next, the other propulsor p 20 located on the opposite side (that is, on the diagonal line) with the gravity center position G of the airframe 10 interposed therebetween with respect to the propulsor 20 stopped in step S11 is switched to an abnormal operation mode (step S12). The “abnormal operation mode” referred to herein refers to a state where measures are taken to completely stop the propulsor 20 or a state where a minimum thrust is generated or a thrust direction is controlled by using the remaining functions. This operation is performed by the drive signal generation unit 32 and the rotation speed control unit 33 described above. In this way, two propulsors 20 among the four propulsors 20 are stopped, and a state is created where the flight is continued only by the remaining two propulsors 20. In this state, the posture determination unit 35 determines whether or not the pitching angle is normal (step S13). In a case where it is determined that the pitching angle is not normal (step S13: No), the rotation speed control unit 33 controls the rotation speeds of the remaining two propulsors 20 to correct the pitching angle (step S14). The pitching angle referred to herein is an angle of the airframe 10 with a direction orthogonal to a straight line connecting the remaining two propulsors 20 as an axis. In a case where the pitching angle is normal (step S13: Yes), the processing proceeds to a subsequent step S15.

In step S15, the posture determination unit 35 determines whether or not the thrust is normal. Specifically, it is determined whether or not thrust sufficient to maintain a predetermined altitude is obtained. In a case where the determination of No is made in step S15, in step S16, the rotation speed control unit 33 controls the rotation speeds of the remaining two propulsors 20 to generate thrust sufficient to obtain a predetermined altitude. When the determination of Yes is made in step S15, the processing proceeds to subsequent step S17. In step S17, the posture determination unit 35 determines whether or not the rolling angle and the yawing angle are normal. The rolling angle is an angle of the airframe 10 with a straight line direction connecting the remaining two propulsors 20 as an axis. The yawing angle is a rotation angle of the airframe 10 with a straight line in the up-down direction passing through the gravity center position G of the airframe 10 as an axis. These rolling angle and yawing angle cannot be corrected or controlled only by controlling the rotation speed of the propulsor 20. Therefore, in a case where the determination of No is made in step S17, the drive signal generation unit 32 operates the thrust vectoring unit 24 to appropriately adjust the thrust directions of the remaining two propulsors 20 (step S18). When the determination of Yes is made in step S17, the operation for landing is started (step S19). By the above, the control flow in a case where abnormality occurs in the propulsor 20 is completed.

### (Operation and Effect)

Here, in the electric flying object 1 of the related art, when one of the plurality of propulsors 20 is stopped due to abnormality, it is common to control the rotation speeds of the remaining propulsors 20 to control the posture of the airframe 10. However, in a case where the posture of the airframe 10 is controlled only by controlling the rotation speed as described above, although the pitching angle can be adjusted, it is difficult to precisely adjust the rolling angle or the yawing angle. Therefore, it becomes difficult to control the airframe 10 at the time of abnormality occurrence, and there is a problem in that the control of the airframe 10 at the time of the abnormality occurrence affects the subsequent landing operation. Therefore, the electric flying object 1 according to the present embodiment adopts each of the configurations described above.

According to the above-described configuration, in a case where one propulsor 20 is stopped due to occurrence of abnormality, the other propulsor 20 located on a side opposite to the stopped propulsor 20 with the center of gravity of the airframe 10 interposed therebetween is switched to an abnormality response mode. In this way, since the unbalance of the thrust caused by stopping one propulsor 20 is eliminated, it is possible to proceed to the next operation such as landing without significantly impairing the balance or the posture of the airframe 10 even in the case of abnormality occurrence. In particular, in the electric flying object 1 including the four propulsors 20 as in the above-described embodiment, when one propulsor propulsor 20 is stopped and three propulsors 20 are driven in the same manner, the unbalance in the magnitude of thrust or the thrust direction is significantly caused, and the control of the airframe 10 is affected. However, according to the above-described configuration, it is possible to reduce such a possibility and stably control the airframe 10.

In addition, according to the above-described configuration, in a case where one propulsor 20 is stopped due to occurrence of abnormality, the other propulsor 20 located on a side opposite to the stopped propulsor 20 with the center of gravity of the airframe 10 interposed therebetween is also stopped. In this way, since the unbalance of the thrust caused by stopping one propulsor 20 is eliminated, it is possible to proceed to the next operation such as landing without significantly impairing the balance or the posture of the airframe 10 even in the case of abnormality occurrence. In particular, in the electric flying object 1 including the four propulsors 20 as in the above-described embodiment, when one propulsor 20 is stopped and three propulsors 20 are driven in the same manner, the unbalance in the magnitude of thrust or the thrust direction is significantly caused, and the control of the airframe 10 is affected. However, according to the above-described configuration, in addition to the propulsor 20 in which the abnormality has occurred, one additional propulsor 20 is also stopped, so that it is possible to reduce such a possibility and stably control the airframe 10.

Further, according to the above-described configuration, the rolling angle is adjusted by operating the thrust vectoring units 24 of the remaining propulsors 20 other than the propulsor 20 stopped due to the occurrence of abnormality. In this way, the disturbance or unbalance of the posture of the airframe 10 caused by the excess or deficiency of the rolling angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10. In particular, since the thrust vectoring unit 24 is provided, it is possible to control the rolling angle even with only the remaining propulsors 20 that can be normally operated. In this way, the robustness of the electric flying object 1 is improved, and even in a case where abnormality occurs, it is possible to greatly reduce a risk of causing damage to the ground due to a crash.

According to the above-described configuration, the yawing angle is adjusted by operating the thrust vectoring units 24 of the remaining propulsors 20 other than the propulsor 20 stopped due to the occurrence of abnormality. In this way, the disturbance or unbalance of the posture of the airframe 10 caused by the excess or deficiency of the yawing angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10. In particular, since the thrust vectoring unit 24 is provided, the yawing angle can be controlled even with only the remaining propulsors 20 that can be normally operated. In this way, the robustness of the electric flying object 1 is improved, and even in a case where abnormality occurs, it is possible to greatly reduce a risk of causing damage to the ground due to a crash.

In addition, according to the above-described configuration, the pitching angle is adjusted by controlling the rotation speed of the remaining propulsors 20 other than the propulsor 20 stopped due to the occurrence of abnormality. In this way, the disturbance or unbalance of the posture of the airframe 10 caused by the excess or deficiency of the pitching angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10.

### <Other Embodiments>

Although the embodiment of the present disclosure has been described in detail above with reference to the drawings, the specific configuration of the present disclosure is not limited to the embodiment, and the present disclosure includes design changes or the like without departing from the scope of the present disclosure.

For example, in the above-described embodiment, a configuration in which one propulsor 20 has a plurality of (four) thrust vectoring units 24 and thrust vectoring actuator units 25 has been described. However, the number of the thrust vectoring units 24 and the number of the thrust vectoring actuator units 25 are not limited thereto, and a configuration shown in FIG. 10 can be adopted as a first modification example. In the example of FIG. 10, each propulsor 20 has only one thrust vectoring unit 24 and one thrust vectoring actuator unit 25. In addition, the airframe 10 is provided with eight propulsors 20, which are more than that in the above-described embodiment. The rotation axis Y of the thrust vectoring unit 24 in each propulsor 20 extends radially around the center of gravity of the airframe 10. That is, the thrust direction can be changed in eight different directions. According to this configuration, in addition to the same operation and effects as those described above, the number of movable portions of each propulsor 20 can be reduced. Therefore, manufacturing costs and maintenance costs can be significantly reduced.

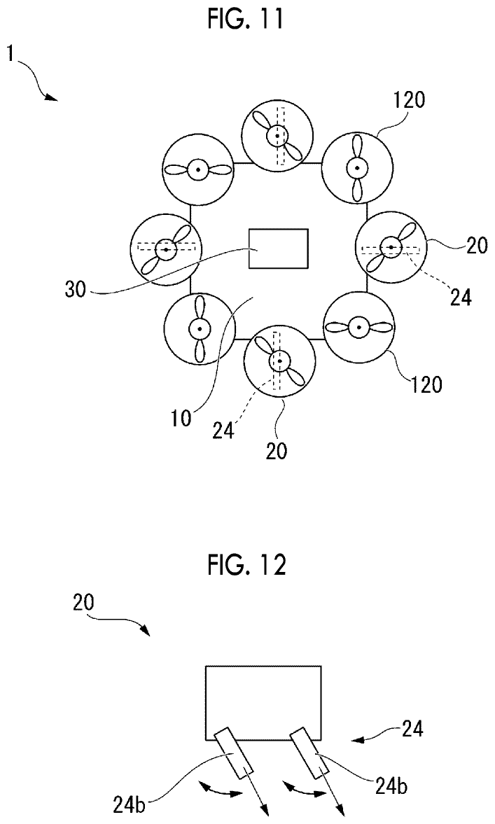

In addition, as shown as a second modification example in FIG. 11, it is also possible to adopt a configuration in which the electric flying object 1 includes the propulsor 20 having the thrust vectoring unit 24 and another propulsor 120 not having the thrust vectoring unit 24. The propulsor 120 has configurations other than the thrust vectoring unit 24, that is, the electric motor 21, the fan 22, and the duct 23. With this configuration as well, the same operation and effects as those described above can be obtained.

In addition, it is also possible to adopt a configuration shown in FIG. 12 as a modification example of the thrust vectoring unit 24. In the example of FIG. 12, the thrust vectoring unit 24 has a nozzle 24b which extends from the duct 23 toward the downstream side of the airflow, and in which a direction of an outlet can be freely changed. The nozzle 24b has a tubular shape, and a flow path through which an airflow flows is formed inside the nozzle 24b. With this configuration as well, the same operation and effects as those described above can be obtained. In addition, the nozzle 24b may be formed of a material that is elastically deformable. Also in this case, the direction in which an outlet-side end portion extends can be changed by an actuator, so that an airflow in a desired direction can be generated.

Further, the shape of the airframe 10 described in the above embodiment is an example, and any shape or dimension and physical size appropriately selected according to design or specifications can be adopted. Even though the shape or the dimension and physical size of the airframe 10 is changed, the configuration and the control flow described in the above embodiment can be applied. In addition, the number of the propulsors 20 may be appropriately determined according to the shape, the dimension and physical size, the weight, or the like of the airframe 10.

In addition, the configuration of the propulsor 20 itself described in the above embodiment is also an example, and a configuration in which a stator vane is further provided on the downstream side of the fan 22 can be adopted. The stator vane is provided to straighten the flow of air pumped by the fan 22. With this configuration as well, the same operation and effects as those described above can be obtained. In addition, the number of the blades 52 or the shape of the blade 52 may be appropriately determined according to design or specifications. Further, the pitch of the blade 52 may be variable.

In addition, in the control unit 30, it is desirable that after the movement direction signal reception unit 31 receives the input of the movement direction D, the generation of the drive signal by the drive signal generation unit 32 and the control of the rotation speed by the rotation speed control unit 33 are autonomously performed. In other words, it is desirable that the user inputs only the movement direction D and the subsequent processing is autonomously performed by the control unit 30. Similarly, a configuration may be made such that after receiving the input of the movement direction D, the yawing is automatically performed by the drive signal generation unit 32 and the rotation speed control unit 33.

The airframe 10 described above may be capable of carrying personnel. In that case, it is desirable that the airframe 10 is equipped with a flight control device and a navigation device.

In addition, a configuration may be made such that the rotation speed of the thrust vectoring unit 24 is changed based on the input of an acceleration in the movement direction D. In this way, the airframe 10 can be precisely controlled in accordance with the input acceleration in the movement direction D.

In a processing flow of the control unit 30 in the embodiment of the present disclosure, the order of processing may be changed in a range in which appropriate processing is performed.

Each of the storage unit 34 and other storage devices in the embodiment of the present disclosure may be provided anywhere in a range in which appropriate information is transmitted and received. Further, each of the storage unit 34 and other storage devices may be present in a plurality in a range in which appropriate information is transmitted and received, and data may be stored in a distributed manner.

The process of the processing by the control unit 30 described above is stored in the form of a program in a recording medium that can be read by a computer 200, and the computer 200 reads out and executes this program, so that the above processing is performed. A specific example of the computer 200 will be described below.

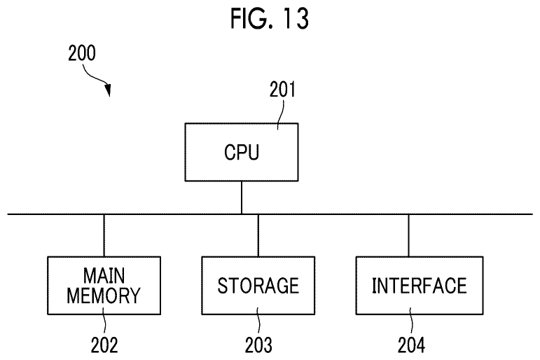

As shown in FIG. 13, the computer 200 includes a CPU 201, a main memory 202, a storage 203, and an interface 204.

For example, the control unit 30 described above is mounted on the computer 200. Then, the operation of each processing unit described above is stored in the storage 203 in the form of a program. The CPU 201 reads the program from the storage 203, develops the program in the main memory 202, and executes the above processing according to the program. Further, the CPU 201 secures a storage area corresponding to the storage unit 34 described above in the main memory 202 according to the program.

As examples of the storage 203, a hard disk drive (HDD), a solid-state drive (SSD), a magnetic disk, a magneto-optical disk, a compact disc read-only memory (CD-ROM), a digital versatile disc read-only memory (DVD-ROM), a semiconductor memory, and the like can be given. The storage 203 may be an internal medium directly connected to a bus of the computer 200 or may be an external medium that is connected to the computer 200 via the interface 204 or a communication line. Further, in a case where this program is distributed to the computer 200 via a communication line, the computer 200 receiving the distribution may develop the program in the main memory 202 and execute the above processing. The storage 203 is a non-temporary tangible storage medium.

In addition, the program may realize some of the functions described above. Furthermore, the program may be a so-called differential file (differential program) that can realize the above-described functions in combination with a program already recorded in the computer 200.

A custom large scale integrated circuit (LSI) such as a programmable logic device (PLD), an application specific integrated circuit (ASIC), a graphics processing unit (GPU), and a processing device similar thereto may be provided in addition to the above-described configuration or instead of the above-described configuration. As examples of the PLD, a programmable array logic (PAL), a generic array logic (GAL), a complex programmable logic device (CPLD), and a field programmable gate array (FPGA) can be given. In this case, a part or all of the functions that are realized by the processor may be realized by the integrated circuit.

### <Additional Remark>

The electric flying object 1 described in each embodiment is understood as follows, for example.

(1) An electric flying object 1 according to a first aspect includes: an airframe 10; a plurality of propulsors 20 provided in pairs to sandwich a center of gravity of the airframe 10 when viewed in a plan view; and a control unit 30 that controls an operation of the propulsor 20, in which the propulsor 20 includes a fan 22 rotatable around an axis X, an electric motor 21 that rotationally drives the fan 22, a duct 23 that covers the fan 22 from an outer periphery side, a thrust vectoring unit 24 that thrust-vectors an airflow generated by the duct 23 on an inner periphery side of the duct 23, and a thrust vectoring actuator unit 25 that controls an angle of the thrust vectoring unit 24, and the control unit 30 switches, in a case where any one of the plurality of propulsors 20 is stopped due to abnormality, the propulsor 20 located on an opposite side to the stopped propulsor 20 with the center of gravity interposed therebetween to an abnormality response mode.

According to the above-described configuration, in a case where one propulsor 20 is stopped due to occurrence of abnormality, the other propulsor 20 located on a side opposite to the stopped propulsor 20 with the center of gravity of the airframe 10 interposed therebetween is switched to an abnormality response mode. In this way, since the unbalance of the thrust caused by stopping one propulsor 20 is eliminated, it is possible to proceed to the next operation such as landing without significantly impairing the balance or the posture of the airframe 10 even in the case of abnormality occurrence.

(2) In an electric flying object 1 according to a second aspect, in the electric flying object 1 according to the above (1), in the abnormality response mode, the propulsor 20 located on the opposite side is stopped.

According to the above-described configuration, in a case where one propulsor 20 is stopped due to the occurrence of abnormality, the other propulsor 20 located on a side opposite to the stopped propulsor 20 with the center of gravity of the airframe 10 interposed therebetween is also stopped. In this way, since the unbalance of the thrust caused by stopping one propulsor 20 is eliminated, it is possible to proceed to the next operation such as landing without significantly impairing the balance or the posture of the airframe 10 even in the case of abnormality occurrence.

(3) In an electric flying object 1 according to a third aspect, in the electric flying object 1 according to the above (2), the control unit 30 adjusts a rolling angle with a travelling direction of the airframe 10 as a roll axis by operating the thrust vectoring units 24 of the propulsors 20 other than at least one pair of the propulsors 20 stopped in the abnormality response mode.

According to the above-described configuration, the rolling angle is adjusted by operating the thrust vectoring units 24 of the remaining propulsors 20 other than the propulsor 20 stopped due to the occurrence of abnormality. In this way, the disturbance or unbalance of the posture of the airframe 10 caused by the excess or deficiency of the rolling angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10.

(4) In an electric flying object 1 according to a fourth aspect, in the electric flying object 1 according to the above (2) or (3), the control unit 30 adjusts a yawing angle with respect to a yaw axis passing through the center of gravity of the airframe 10 by operating the thrust vectoring units 24 of the propulsors 20 other than at least one pair of the propulsors 20 stopped in the abnormality response mode.

According to the above-described configuration, the yawing angle is adjusted by operating the thrust vectoring units 24 of the remaining propulsors 20 other than the propulsor 20 stopped due to the occurrence of abnormality. In this way, the disturbance or unbalance of the posture of the airframe 10 caused by the excess or deficiency of the yawing angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10.

(5) In an electric flying object 1 according to a fifth aspect, in the electric flying object 1 according to any one of the above (2) to (4), the control unit 30 adjusts a pitching angle with a horizontal direction orthogonal to a travelling direction of the airframe 10 as a pitch axis by changing rotation speeds of the propulsors 20 other than at least one pair of the propulsors 20 stopped in the abnormality response mode.

According to the above-described configuration, the pitching angle is adjusted by controlling the rotation speeds of the remaining propulsors 20 other than the propulsor 20 stopped due to the occurrence of abnormality. In this way, the disturbance or unbalance of the posture of the airframe 10 caused by the excess or deficiency of the pitching angle at the time of the abnormality occurrence is corrected, and it becomes possible to bring the airframe 10 close to a normal state. Therefore, even when abnormality occurs, it is possible to proceed to the next operation such as landing without significantly impairing the balance or the posture of the airframe 10.

### INDUSTRIAL APPLICABILITY

According to the present disclosure, it is possible to provide an electric flying object in which it is possible to more precisely control a posture of an airframe at the time of abnormality occurrence.

### REFERENCE SIGNS LIST

1: electric flying object
10: airframe
20: propulsor
21: electric motor
22: fan
23: duct
24: thrust vectoring unit
24a: flap
24b: nozzle
25: thrust vectoring actuator unit
30: control unit
31: movement direction signal reception unit
32: drive signal generation unit
33: rotation speed control unit
34: storage unit
35: posture determination unit
41: electric motor main body
42: output shaft
51: spinner
52: blade
60: stay
120: propulsor
200: computer
201: CPU
202: main memory
203: storage
204 interface
G: gravity center position
M: pitching moment
M′: counter-moment
X: axis
Y: rotation axis
D: movement direction

1. An electric flying object comprising:
an airframe;
a plurality of propulsors provided in pairs to sandwich a center of gravity of the airframe when viewed in a plan view; and
a control unit that controls an operation of the propulsor,
wherein the propulsor includes
a fan rotatable around an axis,
an electric motor that rotationally drives the fan,
a duct that covers the fan from an outer periphery side,
a thrust vectoring unit that thrust-vectors an airflow generated by the duct on an inner periphery side of the duct, and
a thrust vectoring actuator unit that controls an angle of the thrust vectoring unit,
the thrust vectoring unit is a flap, and
the control unit switches, in a case where any one of the plurality of propulsors is stopped due to abnormality, the propulsor located on an opposite side to the stopped propulsor with the center of gravity interposed therebetween to an abnormality response mode.

2. The electric flying object according to claim 1,
wherein in the abnormality response mode, the propulsor located on the opposite side is stopped.

3. The electric flying object according to claim 2,
wherein the control unit adjusts a rolling angle with a travelling direction of the airframe as a roll axis by operating the thrust vectoring units of the propulsors other than at least one pair of the propulsors stopped in the abnormality response mode.

4. The electric flying object according to claim 2,
wherein the control unit adjusts a yawing angle with respect to a yaw axis passing through the center of gravity of the airframe by operating the thrust vectoring units of the propulsors other than at least one pair of the propulsors stopped in the abnormality response mode.

5. The electric flying object according to claim 2,
wherein the control unit adjusts a pitching angle with a horizontal direction orthogonal to a travelling direction of the airframe as a pitch axis by changing rotation speeds of the propulsors other than at least one pair of the propulsors stopped in the abnormality response mode.
